(19) United States
(12) Patent Application Publication
(10) Pub. No.: US 2004/0247492 A1
(43) Pub. Date: Dec. 9, 2004

(54) Process for providing sanitized fresh products

(76) Inventor: Clarence W. Karney, Prescott, AZ (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/825,712

(22) Filed: Apr. 16, 2004

Related U.S. Application Data
(60) Provisional application No. 60/463,879, filed on Apr. 18, 2003.

(51) Int. Cl. G01N 1/00

(52) U.S. Cl. 422/119

(57) ABSTRACT

Methods are disclosed for processing fresh perishable products to assure freedom from pathogens and chemical residue from the point just following harvest to the point of delivery to a retail site and later. The methods provide an improved system for assuring and maintaining pathogen-free products, including fresh fruits, vegetables, herbs, meat, poultry, game, seafood and flowers, until purchased by the consumer and exceed current standards set by the U.S. government.

### CROSS-REFERENCE TO RELATED APPLICATION

This is a non-provisional application claiming priority to provisional application Ser. No. 60/463,879 filed Apr. 18, 2003.

### BACKGROUND OF THE INVENTION

1. Field of the Invention

This invention relates to methods for treating fresh foods, including produce such as fruits and vegetables, to render the food essentially free of illness-causing pathogens, and particularly relates to such methods that assure produce substantially free of illness-causing pathogens from the point of harvest to the point of retail sale of the product.

2. Description of Related Art

It has long been known that pathogens or otherwise deleterious microbes can be present on food products which ultimately make food products harmful for human consumption. It has only been in the last half century, however, that comprehensive steps have been taken to improve food products for human consumption by attempting to assure that such products are sanitary at some level. To that end, the U.S. government has formed agencies for setting standards of cleanliness and sanitation of food products.

While methods of handling and preparing food for retail sale have improved considerably over the last few decades, there have been increasing incidences of severe consumer illnesses, or even death, caused by pathogens or chemical residues borne by food products sold at the retail level. Such incidences of illness have prompted increased efforts to treat foods prior to retail sale. With respect to fresh produce, the predominant method of treating produce for retail sale has been to wash the produce with water, and perhaps a comestible detergent, to remove pathogens and chemical residues.

Under current methods, fresh produce, for example, is typically washed at the point of harvest or just after harvest of the produce. However, during sorting, packaging and transporting of the produce to the point of retail sale, the produce is not treated or tested again to assure that the product is free of pathogens. Therefore, product which has initially been treated arrives at the point of retail sale containing further pathogens or chemicals that cause illness in the consumer. While some consumers may make their own attempts to sanitize fresh produce prior to consumption, such efforts are not always taken and/or are ineffective at killing harmful pathogens and microbes.

Thus, it would be advantageous to provide methods for treating fresh perishable products, especially fresh fruit and vegetables, in a manner that assures a substantially pathogen- and chemical residue-free product from the point of harvest to the point of retail sale, and to provide such methods that exceed current U.S. standards for sanitized or pathogen-free comestible products.

### BRIEF SUMMARY OF THE INVENTION

In accordance with the present invention, methods for treating fresh perishable products, including fruits, vegetables, herbs, flowers, meat, poultry, game, fish, seafood and medical products, are provided which assure that the product attains and retains a state of freedom from pathogens and chemical residue from the point of harvest to the point of retail sale. The present methods achieve or exceed U.S. government standards for pathogenicity in food and other fresh perishable products. The present methods may be applicable to a number and variety of products, but are described herein with respect to fresh fruits and vegetables by way of example only.

In accordance with the methods of the present invention, fresh produce is harvested and collected in the field and is transported to a processing facility. At the facility, the collected produce is washed with a mixture consisting of water and ozone in a particularly selected ratio or combination to assure optimal pathogenicity and chemical residue removal. The initial spray removes chemical residue from the produce and kills substantially all pathogens borne on the produce.

As used herein, the terms “effectively pathogen-free” or “essentially pathogen-free” is meant to imply that the level of pathogens that may be detected under conventional testing conditions is less than the pathogen levels set by current governmental standards (e.g., FDA and/or USDA standards set under the Hazard Analysis and Critical Control Point (HACCP) and Animal and Plant Health Inspection Service (APHIS) guidelines). Current governmental standards require a 5-log pathogen reduction.

The sprayed produce is then sorted and graded. During the sorting and grading process, the produce and the sorting/grading equipment may be continuously contacted with a water/ozone mixture at a temperature selected to maintain a clean environment for handling the produce. The sorted and graded product is then dried and placed in ozone-sanitized packaging under optimal clean room conditions. The packaged product is then maintained in an ozone sanitized and refrigerated environment.

Sample packaged product is chemically tested for levels of pathogens, including but not limited to eColi h157, Salmonella and Listeria. The testing is preferably conducted and monitored by third party entities or governmental agencies, such as the National Food Processors Association, to assure the sanitation of the produce. All testing and monitoring may include visual recording of the events, such as digital photography, which is maintained in centralized databases for accessing and archiving. Verification of quality of the processing may, therefore, be accessed by the end purchaser.

Stored product is then transferred to ozone-sanitized and refrigerated transport means and maintained at a selected temperature to maintain the freshness and pathogen-free environment of the product. Upon delivery of the packaged product to the point of retail sale, the product may be further treated with a water/ozone mixture to maintain the sanitized environment of the product. Sample product may also be tested, again by third party entities, for pathogen levels to assure maintenance of sanitized conditions. The processing of the produce from the time of refrigeration (i.e., following packaging) to the point of retail delivery may be monitored by a global positioning system (GPS) to assure continuous environmental standards for refrigeration temperature, humidity, pressure and location.

In addition to the basic method described previously, the product may preferably be tested and monitored for pH levels, chlorine concentration and oxidation reduction potential (ORP). The product may also undergo additional testing and monitoring for sanitized condition at any point in the harvesting, treatment, packaging, transport and retail display of the product.

Because the process is monitored and recorded, the end consumer can be assured that the product is free of pathogens and chemical residues to a degree that exceeds current governmental standards set by governmental agencies, such as the FDA and USDA, as well as standards set under the HACCP and APHIS. Additionally, the methods of the present invention are shown to maintain very low levels of pathogens for up to thirty days and to extend shelf life by up to forty-five days as compared with other methods of produce treatment.

### BRIEF DESCRIPTION OF THE SEVERAL VIEWS OF THE DRAWINGS

In the drawings, which depict what is currently considered to be the best mode for carrying out the invention:

FIG. 1 is a flow chart illustrating the methods and processes of the present invention; and

FIG. 2 is a schematic depiction of a global positioning system and data collection method of the present invention.

### DETAILED DESCRIPTION OF THE INVENTION

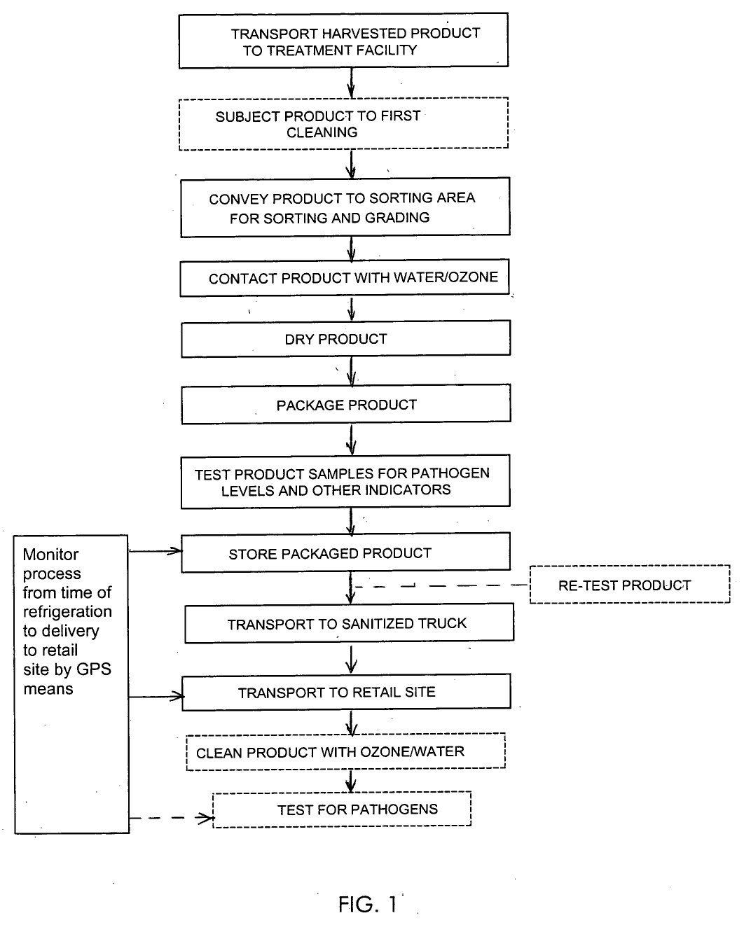

The methods of the present invention for producing and assuring fresh, perishable products that are essentially pathogen-free and chemical-residue free are illustrated in FIG. 1 in a flow chart format. The process begins with the harvesting of the product in the field or other appropriate place. That is, as used herein, the term “harvest” is meant to include not only the traditional notions of harvesting plant materials such as vegetables, fruits, herbaceous plants, grains and flowers, but is also meant to include the collection or processing of animal materials, including fresh meat, poultry, game, fish and seafood. Consequently, as used herein, the term “fresh perishable product” is meant to include any plant or animal product that is sold to consumers in a fresh and perishable state.

Fresh perishable products are transported to a processing facility where the product will undergo the pathogen-reducing methods of the present invention. The fresh perishable products are collected in an appropriate manner at the facility for further sorting and/or packaging following treatment to reduce the pathogen levels of the product. Thus, by way of example only, fresh vegetables may be brought to the facility and deposited in a large bin from where the product is conveyed for further processing.

The facility that is used for the methods of the present invention is particularly structured and maintained for the purposes of retaining optimal cleanliness. That is, the facility is preferably constructed with enclosed rooms for sorting, drying, packaging and storing the product under clean room conditions. The rooms of the facility are constructed with walls, ceilings and floors that are cleaned, preferably twice a day or more, with steam and pressurized ozone applications (e.g. sprayed). The equipment used for conveying the product from sorting to storage is preferably stainless steel and is constructed for frequent cleaning with steam and pressurized ozone to assure constant clean room conditions.

The harvested product is conveyed from the collection bin where it is deposited to a location where sorting and grading, or other pre-packaging evaluation, takes place. The product may be subjected to a first cleaning by any suitable means, including submersion in or spraying with water to remove external dirt, chemicals or other materials and residues. The product may also be subjected to a cleaning with a mixture of water and ozone that is applied in a spray form. The ozone may be produced on site by an ozone generator and mixed with water to produce an admixture of water and ozone that has a selected ability to kill pathogens or microbes.

When the product arrives at the sorting and grading location of the facility it undergoes sorting, grading or other pre-packaging evaluation by humans and/or by machines. The product may be intermittently contacted with a water and ozone mixture during sorting and grading. The water and ozone mixture is preferably maintained at a temperature of between about 60° F. and 65° F. The ambient temperature of the facility, from the point of conveyance of the product to the sorting and grading location to the point of storage, is preferably maintained at between about 60° F. and 65° F.

Following sorting and grading, the product is next conveyed to an area of the facility where the product is contacted with a water and ozone mixture which is particularly selected to kill substantially all pathogens that may be on the product, and to remove any chemical residues from the product to produce an effectively pathogen-free (i.e., greater than a 5-log pathogen reduction) and chemical residue-free product. Again, the ozone is preferably produced by an ozone generator and is mixed with water on site. The mixture of ozone to water is preferably from about 1.0 ppm to about 1.5 ppm.

The product is next dried in any suitable manner to remove external fluid from the product while not drying (i.e., desiccating) the product itself. The product may be dried at ambient temperature or at elevated temperatures up to about 70° F. to about 75° F. The product may be allowed to air dry, or drying may be enhanced or accelerated by use of fans or blower devices. It may be particularly preferred to dry the product in an accelerated manner.

The product is then packaged following the drying process. The product may be packaged in any suitable packaging material, but most preferably is packaged into a container which has been previously subjected to a pathogen-killing material to render the packaging pathogen-free. By way of example only, the packaging may be subjected to an application of or contacting with an ozone and water mixture and then dried prior to filling.

Once the product has been packaged, and preferably before being stored, random samples of packaged product are tested to evaluate the level of pathogens present in the product. Other tests may be conducted at this time, including testing for microbes or other harmful conditions. For example, the product may be tested for the presence of eColi h157, Salmonella, Listeria or any other number or types of pathogens or microbes. The product is also preferably analyzed for pH levels, chlorine levels and oxidation-reduction potential (ORP). It should be noted that testing of pH levels, chlorine levels and ORP may occur at any time from the point of deposit of freshly harvested product to the point of delivery to a retail site.

Testing of the product as described is preferably conducted by third party testers. If sample testing indicates that the product has higher levels of any pathogens or microbes than is allowed or desired, the product may be subjected to further contact with a pathogen-killing agent. Conversely, If the product is determined to be pathogen-free and otherwise possessing the desired characteristics of a fully sanitized product, the packaged product is conveyed to a storage area.

The storage area of the facility is maintained under refrigerated conditions and preferably at a temperature of from about 34° F. to about 56° F., depending on the nature or type of product (i.e. some products can or need to be refrigerated at lower levels (e.g., 34° F.) and some at higher refrigerated levels (e.g., 54° F.). The product may be stored at refrigerated temperatures up to about seven to ten days. When the product is ready for transport to a retail site, the stored product is conveyed from the storage area to a loading area while refrigeration conditions are maintained (i.e., at between about 34° F. to about 56° F. The stored product may optionally be tested for pathogenicity levels, as well as other conditions (e.g., pH levels, ORP, etc.) prior to or as the stored product is being conveyed to transport means for retail distribution.

Refrigerated product from the storage area is maintained under continuous conditions of cleanliness as previously described. In accordance with the methods of the present invention, the product is conveyed to transport means, such as trucks or vans, which have been cleaned under the conditions previously described. That is, the transport means is preferably cleaned with a water and ozone mixture as previously described, or by some other suitable means that may assure an essentially pathogen-free environment. The transport means are also maintained at a refrigerated level of between about 38° F. and about 47° F. until the product reaches a retail site for sale.

In accordance with an embodiment of the invention, the packaged product may optionally be tested and/or cleaned by the method described herein when the product is located at the point of sale. Thus, for example, the product may be tested for pathogenicity or pathogen levels and other product conditions upon arrival at the retail site and/or upon placement at the point of sale (e.g., in the produce section of a grocery store). Alternatively, or following testing, the packaged product may be subjected to cleaning in a manner described herein to further assure that the product remains pathogen-free.

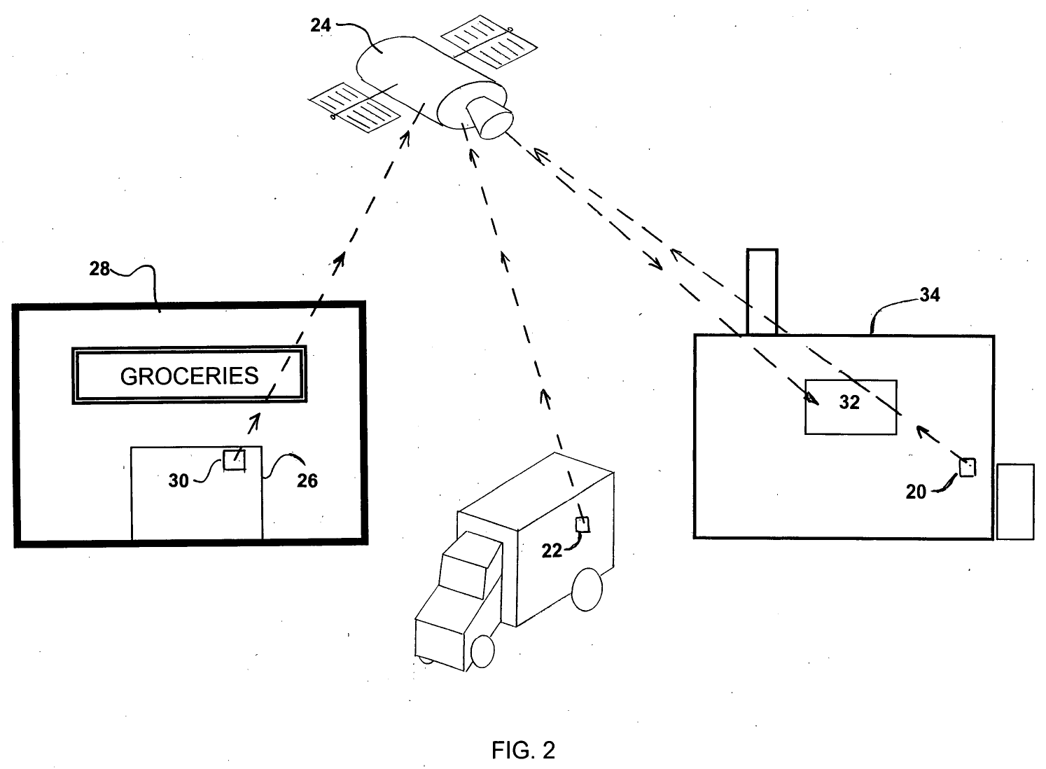

In accordance with an embodiment of the invention depicted in FIG. 2, the product and/or the conditions under which the product is maintained, from the point of conveyance of product to the transport means to the point of delivery at a retail site or at the point of sale, may be monitored by using a global positioning system that is able to receive and transmit to a monitoring device data concerning the real time condition of the product. By way of example, the storage and loading areas of the processing facility and the transport means may preferably be constructed with monitoring devices 20, 22 that are capable of determining and transmitting data regarding such conditions as temperature, humidity, time and location of the product at any given time and transmitting such data to a global positioning system (GPS), such as a satellite 24 or other air-borne receiving and transmitting device. The receiving location 26 of the retail site 28 may also be constructed with a monitor 30 capable of determining and transmitting such data to a GPS device 24.

The GPS 24 is then structured to transmit data concerning the product to a centralized data collection system 32, such as a computer associated with the processing facility 34 or other location. By providing a GPS network for monitoring the conditions of transport, the end user can be assured that the fresh, perishable product has been maintained under optimal conditions that assure essentially pathogen-free product. Additionally, the processing facility is structured with a data collection system 32 which collects and stores data relating to the conditions under which the product is processed from the point of deposit in the bin to the point of loading in a transport means. The data collection system 32 also stores the data derived from testing the product for pathogen levels and any other testing that is conducted (e.g., pH levels, ORP, etc.). In so doing, the ultimate consumer can be assured of the conditions under which the product was processed and that the product remained pathogen-free and chemical residue-free at all times of processing and transporting to the retail site.

The methods of the present invention are provided to assure delivery to the consuming public of fresh, perishable products that are essentially pathogen-free and chemical residue-free. The methods described herein are designed and intended to exceed current practices for assuring pathogen-free fresh products for consumers and exceed all current governmental standards for such assurances. The methods may be modified as needed consistent with the type or nature of the fresh product being processed for pathogen-free conditions, and those of skill in the art will recognize the need for such modifications. Thus, reference herein to specific details of the methods of the present invention are by way of example only and not by way of limitation.

What is claimed is:

1. A method for assuring pathogen-free and chemical residue-free fresh perishable products, comprising:
delivering harvested product to a processing site;
subjecting said harvested product to a first cleaning with an application of a water and ozone mixture;
sorting or grading said product under conditions of continued contact with water and ozone;
drying said product;
packaging said product in sanitized containers;
testing packaged products for levels of pathogens;
storing said packaged product at refrigerated temperatures;
transporting said product to sanitized transport means for retail delivery; and
delivering said product to retail sites.

2. The method according to claim 1 further comprising testing said stored product for pathogen level prior to transporting to said sanitized transport means for retail delivery.

3. The method according to claim 2 further comprising testing said product following delivery of said product to a retail site to assess pathogen levels.

4. The method according to claim 3 further comprising contacting said product with a water and ozone mixture at said retail site to assure continued pathogen-free conditions of said product.

5. The method according to claim 1 further comprising contacting said product with a water and ozone mixture at said retail site to assure continued pathogen-free conditions of said product.

6. The method according to claim 1 wherein said ozone to water mixture is between about 1.0 ppm and about 1.5 ppm.

7. The method according to claim 1 wherein said cleaning, sorting, grading, drying, packaging and storage of said product takes place in an enclosed environment cleaned by diurnal applications of admixed water and ozone.

8. The method according to claim 1 wherein the processing of said product from refrigerated storage to delivery at retail sites is monitored by a global positioning system capable of receiving and transmitting data concerning said product in transit.

9. The method according to claim 1 wherein said product is intermittently tested for pathogen levels during the processing of said product from delivery to the processing facility to the purchase of the product by consumers.

10. The method according to claim 1 wherein said product comprises fresh fruits, vegetables, herbs, flowers, meats, poultry, game and seafood, or combinations thereof.

11. The method according to claim 1 wherein said first cleaning of said product occurs at a temperature of from about 60° F. to about 65° F.

12. The method according to claim 1 wherein said water and ozone mixture is applied to said product in the form or a spray or mist.

13. The method according to claim 1 wherein said product is dried at a temperature of up to about 70° F. to about 75° F.

14. The method according to claim 1 wherein said product is stored at a temperature of from about 34° F. to about 56° F.

15. The method according to claim 1 wherein said product is transported from storage to a retail site at a temperature of from about 38° F. to about 47° F.

16. The method according to claim 1 wherein said packaging of said product occurs at a temperature of from about 60° F. to about 65° F.

17. The method according to claim 1 wherein said product is further tested intermittently from the point of harvest to the point of retail sale for pH levels, chlorine levels, oxidation-reduction potential or combinations thereof.

18. A method for producing and maintaining essentially pathogen-free and chemical residue-free fresh perishable products, comprising:
providing a processing facility having clean room conditions for processing fresh perishable products, said processing facility also having a data collection system;
providing fresh perishable product;
delivering said fresh perishable product to said processing facility for processing;
subjecting said fresh perishable product to a mixture of water and ozone in a percent concentration sufficient to achieve better than a 5-log pathogen reduction in said product;
packaging said product under clean room conditions to maintain said pathogen reduction;
testing said packaged product for pathogenicity below a 5-log pathogen reduction;
storing said packaged product under clean room conditions;
transporting said stored product under clean conditions to retail sites;
monitoring the processing facility conditions from delivery of said fresh perishable product to storage of said product and storing data derived from said monitoring in said data collection system; and
collecting and storing testing data from said testing of said product in said data collection system.

19. The method according to claim 18 further providing a global positioning system structured to receive data relating to the environmental conditions of said product from transport of said product to delivery to a retail site and capable of transmitting said data to said data collection system of said processing facility.

20. The method according to claim 19 wherein said global positioning system includes an air-borne device structured to receive and transmit said data relating to said product.
